(19) United States
(12) Patent Application Publication
(10) Pub. No.: US 2025/0047677 A1
(43) Pub. Date: Feb. 6, 2025

(54) SYSTEMS AND METHODS FOR IMPROVED NETWORK INTRUSIONS PREVENTION

(71) Applicant: Portnox Security, LLC, Austin, TX (US)

(72) Inventors: Karlo ZATYLNY, Dripping Springs, TX (US); Jeremy MORRILL, Austin, TX (US)

(73) Assignee: Portnox Security, LLC, Austin, TX (US)

(21) Appl. No.: 18/787,667

(22) Filed: Jul. 29, 2024

Related U.S. Application Data
(60) Provisional application No. 63/516,806, filed on Jul. 31, 2023.

(51) Int. Cl. H04L 9/40; H04L 61/5014

(52) U.S. Cl. CPC H04L 63/10; H04L 63/0876; H04L 61/5014

(57) ABSTRACT

A system and method for detecting an intruder in a network is provided. An authentication request can be received by a network including a MAC address from an IoT device, and the MAC address can be authenticated. A request can be received for an IP address via DHCP including a DHCP option from the IoT device, and a determination made as to whether the MAC address and the DHCP options sufficiently match. If there is match, access can be allowed to the IoT device and if not output the mismatch.

### CROSS-REFERENCE TO RELATED APPLICATIONS

This application claims priority to and the benefit of U.S. Provisional Application No. 63/516,806, filed on Jul. 31, 2023, the entire contents of which is incorporated herein by reference in its entirety.

### FIELD OF THE INVENTION

The invention relates generally systems and methods for detecting intruders in a network. In particular, to systems and methods for detecting intruders in a secured network with known devices.

### BACKGROUND OF THE INVENTION

In networking there can be secured networks where only certain known devices (e.g., laptops, phones, tv's, and/or other devices as are known in the art) are to have access to the network resources. For example, a corporate organization can have multiple locations (e.g., office space in a building) where each location has a plurality of devices that are to use a network (e.g., internet and/or intranet) that corresponds to the location. Some devices of an organization can travel between the multiple locations (e.g., a laptop of an employee that works in two locations), and other devices can be stationary (e.g., a wall mounted tv).

To help identify devices in a network, techniques have been developed that can use Dynamic Host Configuration Protocol (DHCP) information to perform fingerprinting services to identify a make, model, and/or operating system of a device. Typically, DHCP information from a device is forwarded to the internal network to verify that the device belongs on the network. DHCP information is typically prevented from being shared outside the internal network (e.g., via a firewall).

However, it can be desirable to allow an organization with multiple locations to have access to all network device information, even if they are located in different places.

One difficulty with networks and/or networks having multiple locations can be intruding devices. To gain access to a network that is secured by MAC Address Bypass (MAB) an intruding device can spoof the MAC address of a known good device (e.g., a device that is authenticated to the network). This can make the network access control system believe that an intruder device (e.g., a laptop) is a device secured by MAB (e.g., an Internet of Things (IoT) device like a VoIP phone). Therefore, it can be desirable to provide a more secure network.

### SUMMARY OF THE INVENTION

One advantage of the invention can be an improved security. Another advantage of the invention can be to allow a user with a device to gain access at multiple locations. A centralized cloud service can allow for distributed device management and security against mobile attackers that use information from one location to attack another location. By utilizing information that is typically only used in a local environment at a global level for identification, distributed businesses have an advantage of catching potential threats in near real time such that attackers are identified and quarantined in a relatively fast time period.

In one aspect, the invention involves a method for detecting an intruder in a network. The method involves receiving an authentication request, by the network, including a MAC address from an IoT device. The method also involves transmitting a valid response, by the network, for an authentic MAC address to the IoT device. The method also involves receiving, by the network, a request for an IP address via DHCP including a DHCP option from the IoT device. The method also involves determining, by the network, whether the MAC address and the DHCP options sufficiently match, and if so allowing access to IoT device, if not outputting, by the network, the mismatch.

In some embodiments, the DHCP options are received from a DHCP cloud based database that is populated with DHCP data received from multiple locations. In some embodiments, the authentication request is an 802.1x authentication request. In some embodiments, the authentication request is transmitted from the network to a NAC service in the form of a RADIUS authentication request.

In some embodiments, the MAC address is a preconfigured MAC to perform MAC Authentication Bypass. In some embodiments, the MAC address and the DHCP options do not sufficiently match deny access to the network, send the IoT device to a quarantine network, or any combination thereof. In some embodiments, the IoT device can gain access to the network from multiple physical locations.

In another aspect, the invention includes a system for detecting an intruder in a network. The invention includes a processor configured to receive an authentication request including a MAC address from an IoT device. The processor can also be configured to transmit a valid response for an authentic MAC address to the IoT device. The processor can also be configured to receive a request for an IP address via DHCP including a DHCP option from the IoT device. The processor can also be configured to determine whether the MAC address and the DHCP options sufficiently match, and if so allowing access to IoT device, if not output the mismatch.

In some embodiments, the DHCP options are received from a DHCP cloud based database that is populated with DHCP data received from multiple locations. In some embodiments, the authentication request is an 802.1x authentication request. In some embodiments, the authentication request is transmitted from the network to a NAC service in the form of a RADIUS authentication request.

In some embodiments, the MAC address is a preconfigured MAC to perform MAC Authentication Bypass. In some embodiments, the MAC address and the DHCP options do not sufficiently match deny access to the network, send the IoT device to a quarantine network, or any combination thereof. In some embodiments, the IoT device can gain access to the network from multiple physical locations.

In another aspect, the invention includes a non-transitory computer program product comprising instructions which, when the program is executed cause a processor to receive an authentication request including a MAC address from an IoT device. The computer program product can comprise instructions which when the program is executed cause a processor to transmit a valid response for an authentic MAC address to the IoT device and receive a request for an IP address via DHCP including a DHCP option from the IoT device. The computer program product can comprise instructions which when the program is executed cause a processor to determine whether the MAC address and the DHCP options sufficiently match, and if so allowing access to IoT device, if not output the mismatch.

In some embodiments, the DHCP options are received from a DHCP cloud based database that is populated with DHCP data received from multiple locations. In some embodiments, the authentication request is an 802.1x authentication request. In some embodiments, the authentication request is transmitted from the network to a NAC service in the form of a RADIUS authentication request.

In some embodiments, the MAC address is a preconfigured MAC to perform MAC Authentication Bypass. In some embodiments, the MAC address and the DHCP options do not sufficiently match deny access to the network, send the IoT device to a quarantine network, or any combination thereof. In some embodiments, the IoT device can gain access to the network from multiple physical locations.

### BRIEF DESCRIPTION OF THE DRAWINGS

Non-limiting examples of embodiments of the disclosure are described below with reference to figures attached hereto that are listed following this paragraph. Dimensions of features shown in the figures are chosen for convenience and clarity of presentation and are not necessarily shown to scale.

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous, or similar elements, and in which:

FIG. 1 is a system architecture diagram for an example system including elements for detecting an intruder, according to some embodiments of the invention.

FIG. 2 is a system architecture diagram for an example system including elements for detecting an intruder, according to some embodiments of the invention.

FIG. 3 is a flow chart for a method is a system architecture diagram for a system for detecting an intruder, according to some embodiments of the invention.

FIG. 4 shows a block diagram of a computing device 400 which can be used with embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the invention can be practiced without these specific details. In other instances, well-known methods, procedures, and components, modules, units and/or circuits have not been described in detail so as not to obscure the invention.

Generally, devices can be identified by a media access control (MAC) address. MAC address clustering can be used to identify a device type based on a devices association to other devices. When a device requests an internet protocol (IP) address via DHCP, the operating system can have a unique pattern of DHCP options listed in a distinct order that can allow the device to be identified by this list and ordering.

During operation, if a device requests access (e.g., a spoofing device), a network access control (NAC) system can compare DHCP options from a previously DHCP options obtained from an authenticated device and the current requesting device. If the DHCP options do not match, then the administrator can be alerted. Typically, devices on a network can have a MAC address which can be used to communicate with a wireless access device, and that can be unique for each device. Each MAC address has 6 bytes that uniquely identify the manufacturer. Once the device communicates with the wireless access point, an IP address can be assigned and the DHCP options can be checked. Often intruders can find an address of an IoT device (e.g., find a TV in your network that has a MAC address), and changes the MAC address of their own device (e.g., a laptop) to be the same as the IoT device. However, many intruders typically do not change the DHCP options, such that they have a mismatch between the MAC address and the DHCP options.

For example, an intruder (e.g., spoofer) may obtain the MAC address of a light bulb within a network and then attempt to gain access with the MAC address, however, the intruders DHCP options are of the intruders device and not of a light bulb. The detected disagreement of data can be noted as an anomaly and the administrator of the NAC system can be notified, e.g., via email, SMS, and/or Syslog.

In another example, even if the intruder uses a DHCP options that correspond to the MAC address, the device can be of a type that is not mobile. For example, an intruder takes a MAC address of an IoT light bulb at location one, and attempts to use it at location two.

To provide a global service that is capable of identifying devices across organizations worldwide distributed networks, generally, the invention can involve providing a DHCP listener for DHCP forwarding that can allow a public SaaS service the ability to use a global set of data to identify devices for many networks.

Utilizing a DHCP forwarding feature of popular network devices commonly known as the DHCP Relay Agent, a public SaaS service can receive DHCP data from a variety of global networks and/or provide a central service for device identification. The DHCP packet of information can leave the actual network supplying the DHCP response and can be used for globalized device identification for use in network access policies and VLAN assignment.

Most DHCP listeners are network specific and local to the network. By incorporating a global, internet based DHCP listener, devices can be identified and/or security policies enforced across network boundaries. Generally, the invention can allow for detection devices across distributed distinct networks via one centralized identification and policy enforcement location.

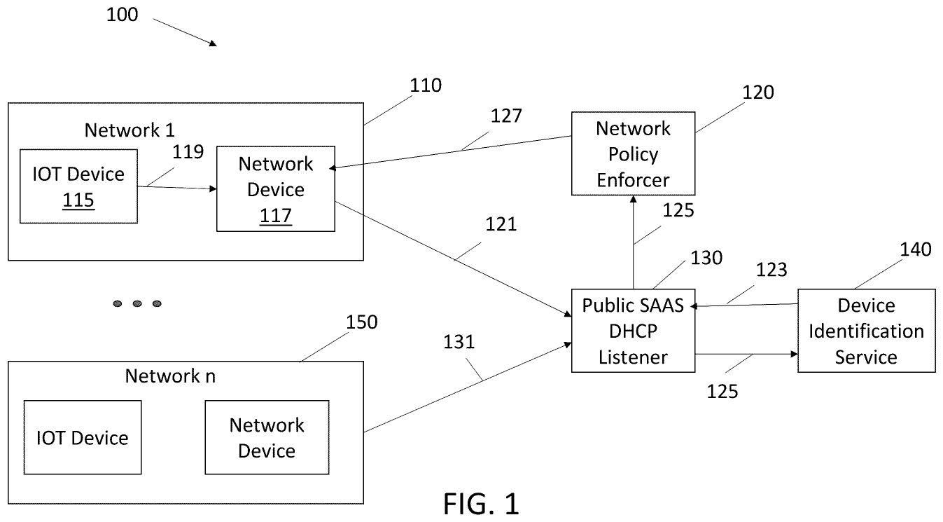

FIG. 1 is a system architecture diagram for an example system 100 including elements for detecting an intruder, according to some embodiments of the invention.

The system 100 can include a first network 110, a network policy enforcer 120, a public SAAS DHCP listener 130, and a device identification service 140. In various embodiments, the system can include any number of network, reflected as Network n 150.

The first network 110 can include an internet-of-things (IoT) device 115 and a network device 117. The first network 110 can communicate with the network policy enforcer 120 and/or the public SAAS DHCP listener 130. The public SAAS DHCP listener 130 can communicate with the device identification service 140.

In various embodiments, the network policy enforcer 120, the public SAAS DHCP listener 130, the device identification service 140 or any combination thereof, can be on one or more servers associated with the service (e.g., cloud service) and/or on a redundant set of virtual machines.

During operation, the IoT device 115 of the first network 110 can transmit a request 119 that includes DHCP options to the network device 117. The network device 117 can receive the DHCP request and transmit the DHCP request 121 to the public SaaS DHCP listener 130. The SaaS DHCP listener 130 can uses the DHCP options to perform device identification by transmitting a device authentication request 123 to the device identification service 140. The device identification service 140 can identify the IoT device 115 and transmit 125 a identification message to the public SaaS DHCP listener 130. The IoT device identification is transmitted by the public SaaS DHCP listener 130 to network policy enforcement service 120. The network policy enforcement service 120 can transmit 127 the device network access and VLAN assignment to the network device 117 e.g., via a Remote Authentication Dial-In User Service (RADIUS) packet update. Network n 150 can transmit a request 131 to the Public SAAS DHCP listener 130 similar to the first network 110 causing similar messaging as has been described with respect to the first network 110.

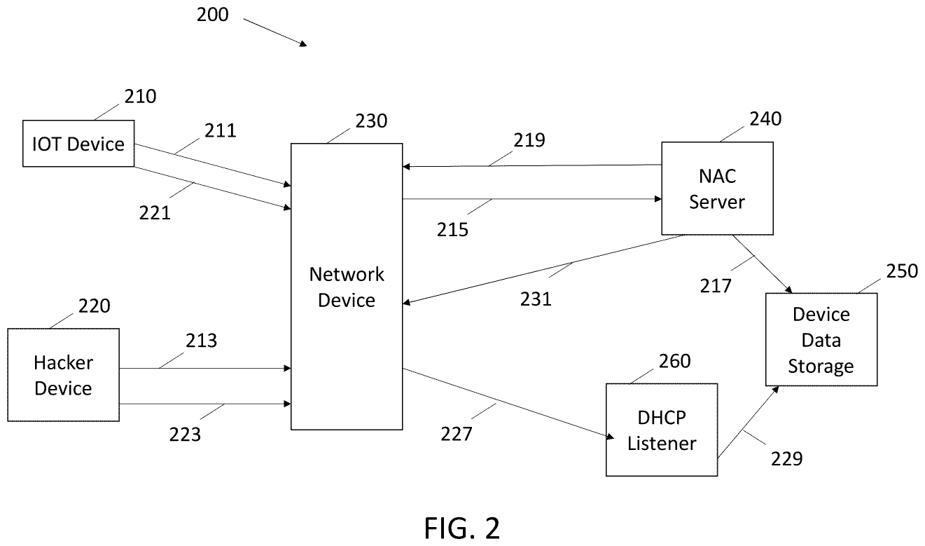

FIG. 2 is a system architecture diagram for an example system architecture 200 including elements for detecting an intruder, according to some embodiments of the invention.

The system architecture 200 includes a IoT device 210, hacker device 220, network device 230, network access controller (NAC) server 240, SaaS DHCP listener 260, and device data storage 250.

The IoT device 210 can communicate with the network device 230. The network device 230 can communicate with the NAC server 240 and the DHCP listener 260. The NAC server 240 and the DHCP listener 260 can communicate with the device data storage 250. The hacker device 220 can be an IoT device.

During operation, the IoT device 210 can transmit a 802.1x authentication request 211 to the network device 230. The authentication request 211 can include a MAC address. The IoT device 210 can be a valid IoT device, for example a device that is validly connected to the network. The hacker device 220 (e.g., operated by an intruder) can transmit a 802.1x authentication request 213 to the network device 230 with a MAC address other than its own, a MAC address that is a valid address of the network.

The network device 230 can transmit the received MAC address (e.g., from either the IoT device 210 or the hacker device 220) in a authentication request 215 (e.g., RADIUS authentication request) to the NAC service 240.

The NAC server 240 can validate that the MAC address is a preconfigured MAC (e.g., by comparing against a predefined list of valid MAC addresses or a MAC address vendor whitelist), perform a MAC Authentication Bypass, and/or identify the device type as indicated by the MAC address. The NAC server 240 can transmit 217 the device type to device data storage 250 for storage.

The NAC server 240 can transmit an authentication granted message 219 (e.g., RADIUS authentication granted) to the network device 230 to indicate that the requesting device, either the IoT device 210 or the hacker device 220 is allowed on the network.

Either the IoT device 210 or the hacker device 220 transmits to the network device 230. If the IoT device 210 is the requesting device (e.g., transmitted the message 211), then the IoT device 210 transmits a DHCP request 221 including an IP address via DHCP including DHCP options to the network device 230. If the hacker device 220 is the requesting device (e.g., transmitted the message 213), then the hacker device 220 transmits a DHCP request 223 with its default operating system options to the network device 230.

The network device 230 forwards the DHCP request 227 to the SaaS DHCP listener 260.

The SaaS DHCP listener 260 forwards the DHCP options and MAC address 229 to NAC service 240. The NAC service 240 identifies the device via the DHCP options and stores the DHCP options in the device data storage 250.

The NAC server 240 can compare DHCP options from the current request, either from the IoT device 210 or the hacker device 220, to DHCP options from previous requests and if MAC device type matches previous DHCP options, no action, otherwise:

If the MAC device type does not match DHCP options device type then one or more of the following can occur:
i) transmit 231 a message from the NAC server 240 to the networking device 230 indicating that the device is unauthorized and indicating the network device to send the requesting device to connect to a guest network, a quarantine network and/or a virtual local area network;
ii) transmit 231 a message from the NAC server 240 to the networking device 230 to deny network access to the requesting device; and/or
iii) notify a system administrator of device compatibility issue by transmitting an email or popup notification to a smart phone device.

For example, an IoT device (e.g., IoT device 115 as shown above in FIG. 1) can initially authenticate with a network using a MAC Address Bypass protocol. In this example, this information can be sent to a RADIUS service with an example MAC Address of 11:22:33:44:55:66. The MAC Address can be used to identify the device as coming from a particular device manufacturer like XYZ printers. Once allowed on the network, the IoT device can use the DHCP protocol to request an IP address so that it can use layer 3 protocol routing for communication to other devices on the network. This DHCP request can have flags in it that can be in a unique order. In this example, the flags can be 01,02,03,04. The DHCP information can be forwarded to a DHCP listener (e.g., DHCP listener on the cloud) that can then send the DHCP information to a device identification service (e.g., device identification service 140 as shown above in FIG. 1). The set of flags can be checked by the device identification server against a set of known device DHCP flag requests combined with the already known MAC address to determine a type for the device.

In this example, the device can be identified as XYZ Printers Model 1234. Based on this identification, the network policy enforcer (e.g., network policy enforcer 120 as shown above in FIG. 1) can send a change of authorization packet to the network device (e.g., network device 117 as shown above in FIG. 1) letting it know to place this device on an example VLAN 73, which can be an example VLAN for printers in the example network.

Continuing with the above example, a new device which is a device controlled by a hacker can steal the MAC address of the printer and presents itself to the network with MAC address 11:22:33:44:55:66. In this example, the network MAC Address Bypass protocol works and the device can be allowed on the network. The hacker device, which in this example is a laptop, then requests an IP address using the DHCP protocol. The laptop send DHCP flags 05,02,03,04. This pattern can be sent to the cloud DHCP listener and then to the device identification service which determines based on the DHCP flags that the transmitting device is not an XYZ Printer but is instead likely an ABC laptop. Since the DHCP signature does not match the previously identified device, the system can notify the network via a change of authorization packet to place the device in a quarantine VLAN and an alert notification message via email or other service can be sent to the administrator noting the potential attacker on the network.

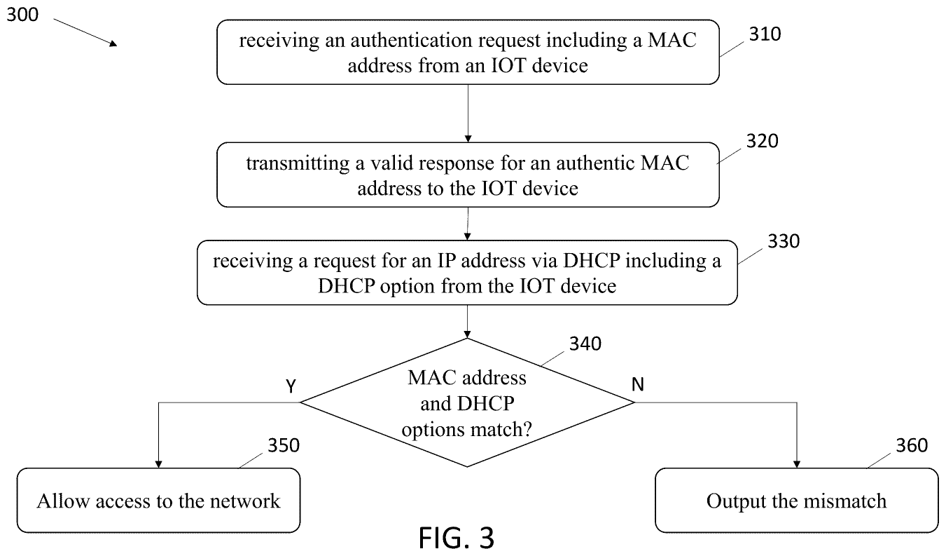

FIG. 3 show a method 300 for detecting an intruder in a network, according to some embodiments of the invention.

The method can involve receiving an authentication request (e.g., by a network device 230 as shown above in FIG. 2) including a MAC address from an IoT device. The IoT device can be a valid IoT device of the network (e.g., IoT device 210 as shown above in FIG. 2) or a hacker's device (e.g., hacker device 220 as shown above in FIG. 2).

The method can involve transmitting a valid response for an authentic MAC address to the IoT device (e.g., message 219 from the NAC server 240 to the network device 230 as described above in FIG. 2).

The method can involve receiving a request for an IP address via DHCP including a DHCP option from the IoT device (e.g., message 221 from IoT device 210 or message 223 from hacker device 220 as described above in FIG. 2).

The method can involve determining whether the MAC address and the DHCP options sufficiently match (e.g., via NAC server 240 as described above in FIG. 2) and if so allowing access to the IoT device, if not outputting the mismatch.

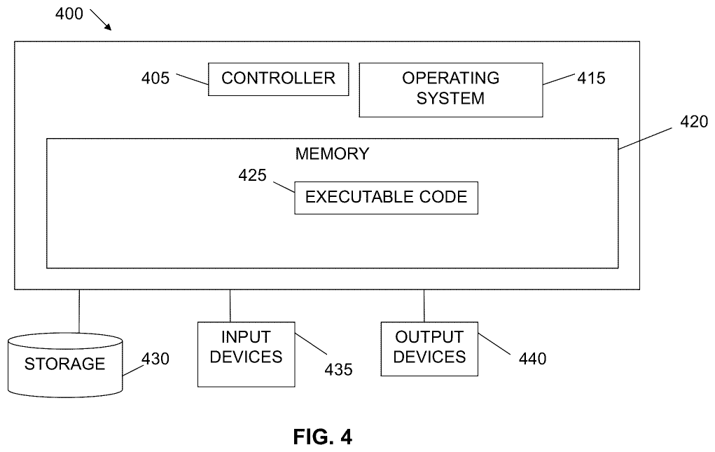

FIG. 4 shows a block diagram of a computing device 400 which can be used with embodiments of the invention. Computing device 400 can include a controller or processor 405 that can be or include, for example, one or more central processing unit processor(s) (CPU), one or more Graphics Processing Unit(s) (GPU or GPGPU), a chip or any suitable computing or computational device, an operating system 415, a memory 420, a storage 430, input devices 435 and output devices 440.

Operating system 415 can be or can include any code segment designed and/or configured to perform tasks involving coordination, scheduling, arbitration, supervising, controlling or otherwise managing operation of computing device 400, for example, scheduling execution of programs. Memory 420 can be or can include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 can be or can include a plurality of, possibly different memory units. Memory 420 can store for example, instructions to carry out a method (e.g. code 425), and/or data such as user responses, interruptions, etc.

Executable code 425 can be any executable code, e.g., an application, a program, a process, task or script. Executable code 425 can be executed by controller 405 possibly under control of operating system 415. For example, executable code 425 can when executed cause masking of personally identifiable information (PII), according to embodiments of the invention. In some embodiments, more than one computing device 400 or components of device 400 can be used for multiple functions described herein. For the various modules and functions described herein, one or more computing devices 400 or components of computing device 400 can be used. Devices that include components similar or different to those included in computing device 400 can be used, and can be connected to a network and used as a system. One or more processor(s) 405 can be configured to carry out embodiments of the invention by for example executing software or code. Storage 330 can be or can include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, NN model data, parameters, etc. can be stored in a storage 430 and can be loaded from storage 430 into a memory 420 where it can be processed by controller 405. In some embodiments, some of the components shown in FIG. 3 can be omitted.

Input devices 435 can be or can include for example a mouse, a keyboard, a touch screen or pad or any suitable input device. It will be recognized that any suitable number of input devices can be operatively connected to computing device 400 as shown by block 435. Set of fa devices 440 can include one or more displays, speakers and/or any other suitable output devices. It will be recognized that any suitable number of output devices can be operatively connected to computing device 400 as shown by block 440. Any applicable input/output (I/O) devices can be connected to computing device 400, for example, a wired or wireless network interface card (NIC), a modem, printer or facsimile machine, a universal serial bus (USB) device or external hard drive can be included in input devices 435 and/or output devices 440.

Embodiments of the invention can include one or more article(s) (e.g. memory 420 or storage 430) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stores on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

What is claimed is:

1. A method for detecting an intruder in a network, the method comprising:
receiving an authentication request, by the network, including a MAC address from an IoT device;
transmitting a valid response, by the network, for an authentic MAC address to the IoT device;
receiving, by the network, a request for an IP address via DHCP including a DHCP option from the IoT device; and
determining, by the network, whether the MAC address and the DHCP options sufficiently match, and if so allowing access to IoT device, if not:
outputting, by the network, the mismatch.

2. The method of claim 1 wherein the DHCP options are received from a DHCP cloud based database that is populated with DHCP data received from multiple locations.

3. The method of claim 1 wherein the authentication request is an 802.1x authentication request.

4. The method of claim 1 wherein the authentication request is transmitted from the network to a NAC service in the form of a RADIUS authentication request.

5. The method of claim 1 wherein the MAC address is a preconfigured MAC to perform MAC Authentication Bypass.

6. The method of claim 1 wherein if the MAC address and the DHCP options do not sufficiently match deny access to the network, send the IoT device to a quarantine network, or any combination thereof.

7. The method of claim 1 wherein the IoT device can gain access to the network from multiple physical locations.

8. A system for detecting an intruder in a network, the system comprising:
a processor configured to:
receive an authentication request including a MAC address from an IoT device;
transmit a valid response for an authentic MAC address to the IoT device;
receive a request for an IP address via DHCP including a DHCP option from the IoT device; and
determine whether the MAC address and the DHCP options sufficiently match, and if so allowing access to IoT device, if not:
output the mismatch.

9. The system of claim 8 wherein the DHCP options are received from a DHCP cloud based database that is populated with DHCP data received from multiple locations.

10. The system of claim 8 wherein the authentication request is an 802.1x authentication request.

11. The system of claim 8 wherein the authentication request is transmitted from the network to a NAC service in the form of a RADIUS authentication request.

12. The system of claim 8 wherein the MAC address is a preconfigured MAC to perform MAC Authentication Bypass.

13. The system of claim 8 wherein if the MAC address and the DHCP options do not sufficiently match deny access to the network, send the IoT device to a quarantine network, or any combination thereof.

14. The system of claim 8 wherein the IoT device can gain access to the network from multiple physical locations.

15. A non-transitory computer program product comprising instructions which, when the program is executed cause a processor to:
receive an authentication request including a MAC address from an IoT device;
transmit a valid response for an authentic MAC address to the IoT device;
receive a request for an IP address via DHCP including a DHCP option from the IoT device; and
determine whether the MAC address and the DHCP options sufficiently match, and if so allowing access to IoT device, if not:
output the mismatch.

16. The non-transitory computer program product of claim 15 wherein the DHCP options are received from a DHCP cloud based database that is populated with DHCP data received from multiple locations.

17. The non-transitory computer program product of claim 15 wherein the authentication request is an 802.1x authentication request.

18. The non-transitory computer program product of claim 15 wherein the authentication request is transmitted from the network to a NAC service in the form of a RADIUS authentication request.

19. The non-transitory computer program product of claim 15 wherein the MAC address is a preconfigured MAC to perform MAC Authentication Bypass.

20. The non-transitory computer program product of claim 15 wherein if the MAC address and the DHCP options do not sufficiently match deny access to the network, send the IoT device to a quarantine network, or any combination thereof.
